(19) United States
(12) Patent Application Publication
(10) Pub. No.: US 2008/0007563 A1
(43) Pub. Date: Jan. 10, 2008

(54) Pixel history for a graphics application

(75) Inventors: David F. Aronson, Woodinville, WA (US); Michael D. Anderson, Redmond, WA (US); Michael R. Burrows, Redmond, WA (US); Paul L. Bleisch, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/483,709

(22) Filed: Jul. 10, 2006

(51) Int. Cl. G09G 5/02

(52) U.S. Cl. 345/589

(57) ABSTRACT

Various embodiments are disclosed relating to providing a pixel history for a graphics application. During rendering of a visual representation, such as a computer game or visual simulation, a developer or other user may observe a rendering error, e.g., with respect to a rendered pixel, or may wish to optimize or understand an operation of the visual representation. The developer may select the pixel and be provided with a browsable pixel history window that shows a temporal, sequential order of events associated with the rendering of the selected pixel. The events may include calls from the graphics application to an associated graphics interface, and information about the calls may include asset data associated with the calls as well as primitives associated with the calls.

### BACKGROUND

Images and graphics may be rendered using a computer and associated display, so that users may use and enjoy, for example, computer games, virtual world or other simulations, e-learning courses, or many other types of computer-based visual representations. A developer may use a graphics application to develop and produce such visual representations. Such graphics applications may involve, for example, the rendering of a continuous series of frames, where each frame comprises sub-parts, such as objects or individual pixels. The visual representations, which may be very realistic in their final appearance, are built up from very basic elements or data, such as, for example, basic shapes such as lines or triangles, basic colors that are combined to obtain a desired color, basic texture descriptions, and other basic elements associated with specific aspects of a visual representation. Generally speaking, a graphics application uses these basic elements and data in conjunction with a graphics application program interface (API), or graphics interface, to render the visual representations using computer hardware and an associated display.

As evidenced by the early history of graphics applications, when fewer and/or larger basic elements and data are used, the resulting visual representations may be “blocky” or may otherwise include obvious departures from realistic visual depictions. As graphics applications advance, however, they are able to interact with their associated graphics interfaces in an ever-faster fashion, and are able to use and combine ever-more of the basic elements and data just referenced. Specifically, graphics applications are more and more capable of making an increased number of calls to their associated graphics interface(s) that instruct the graphics interface(s) as to which and how such basic elements should be used/combined. In turn, the graphics interfaces are more and more capable of interacting with drivers and other hardware to render the visual representations in a manner that is realistic to the human eye.

However, as the detail and complexity of the visual representations grow, a developer's difficulties in creating, using, and optimizing the visual representations also may grow. For example, it may become more and more difficult for a creator or developer of the graphics application to determine, for example, which of the thousands or millions of calls to the graphics interface from the graphics application was responsible for an error in the resulting visual representation. For example, the developer may develop a new game, and may then test the game for performance. During the testing, the developer may observe an error in the visual representation, such as, for example, a portion of the rendered screen that exhibits an incorrect color, shading, or depth. However, the erroneous portion of the visual representation may result from, or be associated with, the combination of thousands or millions of operations of the graphics application and/or graphics interface. Therefore, the developer may spend significant time before even determining a possible source of the error, much less a correction to the error. As a result, an efficiency and productivity of the developer may be reduced, and the quality and time-to-market of a resulting product (e.g., game or simulation) may potentially be reduced, as well.

Further, even if no explicit errors are included in the visual representation, it may be the case that the visual representation is not created or executed in an optimal fashion. For example, a visual representation may render correctly, but may do so more slowly if rendered back-to-front (e.g., in a 3D representation), rather than front-to-back. Still further, the various complications and difficulties just mentioned, and others, may be particularly experienced by beginning or practicing developers, so that it may be problematic for such developers to improve their skill levels.

### SUMMARY

By virtue of the present description, then, graphics developers may be provided with straight-forward tools and techniques for, for example, determining a source of an error within a visual representation with a high degree of accuracy, for optimizing an operation or presentation of the visual representation, and for learning or understanding coding techniques used in coding the visual representation. For example, a developer viewing or testing a visual representation may observe an error within the visual representation, such as an incorrect color, shading, or depth. The developer may then select, designate, or otherwise identify the erroneous portion of the visual representation, e.g., by way of a simple mouse-click. In response, the developer may be provided with a browsable, interactive graphical user interface (GUI) that presents the developer with a history and description of the rendering of the erroneous portion. Similar techniques may be used in optimizing the visual representation, or in understanding coding techniques used for the visual representation.

For example, the developer may select a portion of the visual representation that is as specific as a single pixel of the visual representation, and may be provided with a GUI such as just referenced, e.g., a pixel history window, that provides the developer with a sequence of events between an underlying graphics application and graphics interface that were associated with the rendering of the selected pixel. The sequential listing of the events may include, for each event, the ability to “click through” to the data or other information associated with that event, including information about the most basic or “primitive” shape(s) used to construct or render the selected pixel (e.g., a line or triangle). In example implementations, the listing of events include only those events which actually affect, or were intended to have affected, the selected pixel.

Moreover, such example operations are performed in a manner that is agnostic to, or independent of, a particular type of graphics hardware (e.g., a graphics driver). Moreover, such example operations may be implemented exterior to the underlying graphics application, i.e., without requiring knowledge or use of inner workings or abstractions of the graphics application. Accordingly, resulting operations may be straight-forward to implement, and applicable to a wide range of scenarios and settings.

Consequently, for example, the developer may quickly determine how a pixel was rendered, whether the rendering was sub-optimal, and/or may determine a source of an error of the rendered pixel. This allows the developer to understand, improve, or correct the error, e.g., within the (code of the) graphics application, in a straight-forward manner, so that the productivity and efficiency of the developer may be improved, and a quality and time-to-market of the graphics application also may be improved.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of an example system for providing a pixel history for a graphics application.

FIG. 2 is a flow chart illustrating example operations of the system of FIG. 1.

FIG. 3 is an example embodiment of a pixel history window provided by the system of FIG. 1.

FIG. 4 is a flow chart illustrating example operations used by the system of FIG. 1 to implement the pixel history window of FIG. 3.

### DETAILED DESCRIPTION

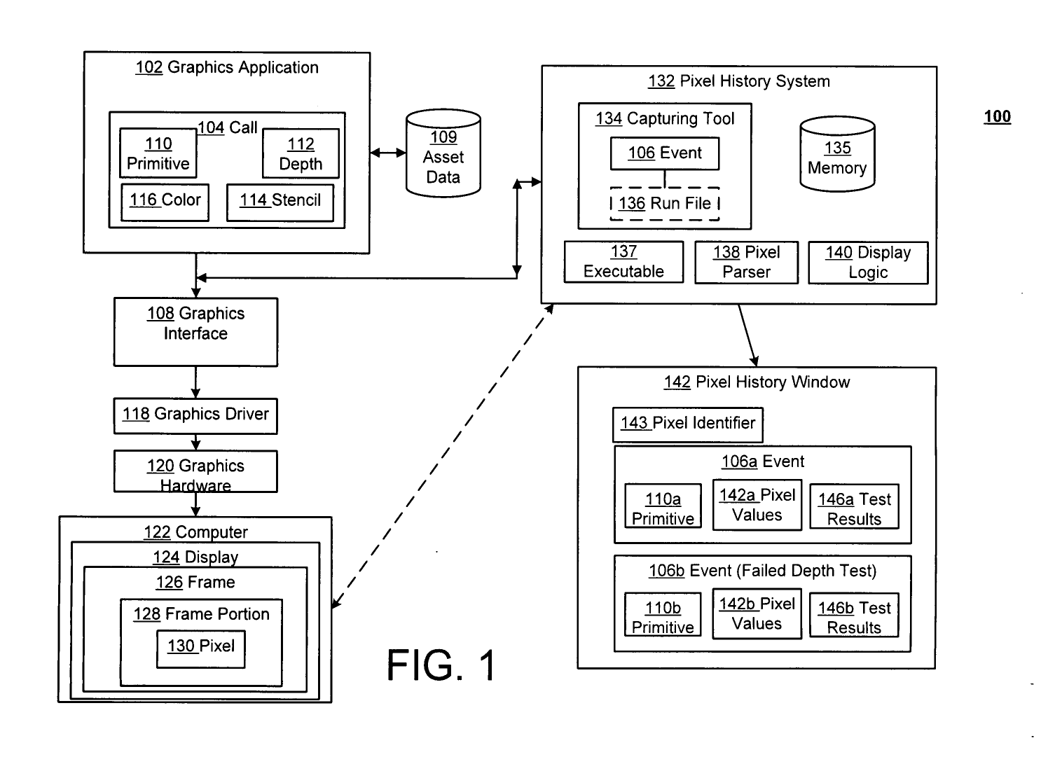

FIG. 1 is a block diagram of an example system 100 for providing a pixel history for a graphics application 102. The system 100 is operable to permit a developer or other user to select a portion of a visual representation that is rendered using the graphics application 102, and thereafter to provide the developer with information about the selected portion, which may be as small as a single pixel, so that the developer may, for example, debug, optimize, or understand code of the graphics application 102.

For example, the developer may click on or otherwise select an (e.g., erroneously-rendered) pixel of a visual representation and/or select “pixel history” to thereby obtain a browsable window to see a temporal sequence of every event that affected the selected pixel, as well as every primitive that affects the event(s). This allows the developer to scroll through the browsable window and see the history of the selected pixel; for example, the selected pixel may start as the color red, then change to the color white, then change texture, and so on. Accordingly, the developer may determine information about each event that caused an effect on the selected pixel, and may thus determine errors that may have lead to the observed rendering error associated with the selected pixel.

Thus, the graphics application 102, as referenced above, may generally be used to generate such visual representations, such as, for example, a video game or a simulation (e.g., a flight simulation). As also just referenced, the graphics application 102 may generate a call 104. The call 104 may, for example, include or specify a number of elements which instruct a graphics interface 108 as to how to issue commands for rendering the visual representation. In other words, the graphics interface 108 represents a set of tools or capabilities that are generic to a large number of graphic applications, and that allow such graphics applications to achieve a desired effect.

Thus, the graphics application 102 may interact with the graphics interface 108 using the call 104, which may contain, or reference, known (types of) elements or data. For example, the graphics application 102 may, in the call 104, reference or use elements from related asset data 109. That is, the asset data 109 may represent, for example, information that is used by the graphics application 102 for a particular visual simulation. For example, the type and amount of asset data 109 required by the graphics application 102 for a high-speed, 3-dimensional video game may be quite different in amount and extent from that required for a 2-dimensional rendering of a largely static image. Thus, the graphics interface 108 represents a set of tools that is generic to a large number of graphics applications, where each (group of) graphics application(s) (e.g., the graphics application 102) may access its own asset data 109.

In the following discussion, an in FIG. 1, the call 104 is represented as including a primitive 110, a depth value 112, a stencil value 114, and a color value 116. It should be understood that this representation in intended to be conceptual, and for the purposes of illustration/discussion, and is not intended to provide a detailed description of a function of the call 104. For example, one of skill in the art will appreciate that the call 104 does not “include” these elements, but, rather, directs the graphics interface 108 (and, ultimately, a graphics driver 1118, graphics hardware 120, and/or computer 122) as to how to render these and other elements/features. For example, in practice, the call 104 may include a draw call with instructions to the graphics driver 118 and/or graphics hardware 120 to render one or more primitives 110, with each primitive overlapping one or more pixels. The graphics driver 118 and/or graphics hardware 120 determine and maintain color, depth, and stencil values at each pixel as a consequence of the rasterization of each primitive.

Thus, the call 104 is illustrated as using or including a primitive 110, in the sense just described. As referenced above, the primitive 110 may refer to a most-basic element (e.g., a line or triangle) used to construct a visual representation. As such, the call 104 may typically specify a large number of such primitives. Moreover, since the primitive 110 is at such a base level of representation, the primitive 110 often is combined with other primitives to form a standard object, which may itself be the element that is typically specified by the graphics application 102 in the call 104. As a result, it may be particularly difficult for the developer to ascertain information regarding the primitive 110 within the call 104, since the primitive 110 must be parsed from a large number of primitives, and from within the call 104 that itself represents a large number of calls.

The call 104 also may include or reference, in the sense described above and for example, a depth value 112, a stencil value 114, and/or a color value 116. The depth value 112 may, for example, be used to identify depth coordinates in three-dimensional graphics. For example, an object (e.g., a car) in a visual representation may drive either in front of or behind another object (e.g., a building), depending on a depth value(s) associated with the objects and their respective pixels. The stencil value 114 may, for example, be used to limit a rendered area within the resulting visual representation. The color value 116 may, for example, indicate what color a given pixel should render in terms of a red, green, blue value (RGB value). It should be appreciated that the above examples of elements or features of the call 104, and other examples provided herein, are merely provided for the sake of illustration, and are not intended to be exhaustive or limiting, as many other examples exist.

Thus, the graphics application 102 may make the call 104, for example, to the graphics interface 108. The graphics interface 108, as referenced above, may describe a set of functions that may be implemented by the graphics application 102. The graphics interface 108 may, for example, include a graphics application programming interface such as Direct3D (D3D), or, as another example, may include a graphics interface such as OpenGL, or any graphics interface configured to receive calls from the graphics application 102.

The graphics interface 108 may thus use the call 104 to communicate with, and operate, a graphics driver 118. The graphics driver 118 may represent or include, for example, virtually any graphics card, expansion card, video card, video adaptor, or other hardware and/or software that is configured to convert the logical output of the graphics interface 108 into a signal that may be used by graphics hardware 120 so as to cause a computer 122, having a display 124, to render an image frame 126.

FIG. 1 illustrates an example in which the graphics driver 118 is separate from the graphics hardware 120, which is separate from the computer 122. Of course, this is just an example, and in actuality, these various components may be integrated with one another to some extent, and their various functions and capabilities may overlap, as well. The graphics application 102 also may run on the computer 122, or on another computer that is in communication with the computer 122. To the extent, however, that the graphics driver 118 communicates more directly with the graphics hardware 120 and/or the computer 122, it should be understood that communications there-between will generally be particular to, or dependent upon, a type or platform of the various hardware components (e.g., the graphics driver 118, the graphics hardware 120, the computer 122, as well as the display 124, which may represent various types of displays having various resolutions, as would be apparent). Conversely, the graphics application 102 and/or the graphics interface 108, and communications there-between, are not generally dependent upon the various hardware components. Of course, the graphics application 102 and the graphics interface 108 have some minimum acceptable performance requirements (e.g., processing speed and memory, e.g., of the computer 122), but such requirements are relatively generic to virtually all types of computing platforms.

The computer 122 may represent, but need not be limited to, a personal computer. The computer 122 additionally or alternatively may include, for example, a desktop computer, a laptop, a network device, a personal digital assistant, or any other device capable of rendering a signal from the graphics hardware 120 into the desired visual representation. As described, the computer 122 may then, for example, send a signal to the display 124, which may include a screen connected to the computer 122, part of the laptop computer 122, or any other suitable or desired display device.

The display 124 may then render a frame 126 of a visual representation, the frame 126 including a frame portion 128 that includes at least one pixel 130. Of course, the frame portion 128 may include many pixels 130, where it will be appreciated that the pixel 130 may represent one of the smallest, or the smallest, element of the display 124 (and the graphics application 102) that may be displayed to the developer or other user.

In many of the following examples, situations are described in which a rendering error occurs and is observed within the frame 126. However, it should be understood that in many examples, as referenced above, a rendering error need not occur, and that other motivations exist for observing a pixel history (e.g., optimization or understanding of code of the graphics application 102). Thus, the developer may then, for example, view the frame 126 on the display 124, and find that the frame 126 does not appear in an intended manner, e.g., contains a rendering error. The developer may, for example, find that the frame 126 renders a blue building, when the frame 126 was intended to render the building as being white, or vice-versa. As another example, a depth of an object may be incorrect. For example, a rendered car may be intended to be shown as driving behind the building, but may instead appear in front of the building. Such types of undesired outcomes are well-known to developers, and include many examples other than the few mentioned herein.

In some example implementations, then, such as in the example of the system 100, the developer may then, for example, select a pixel 130 used to render the building (i.e. a pixel appearing to be white rather than blue) from within the frame 126, which is the problematic frame in which the undesired outcome occurred. The developer may then, for example, request a pixel history on the pixel 130 to help determine what is wrong (e.g. why the building rendered as white instead of blue). For example, the developer may right-click on the pixel 130 and be provided with a pop-up window that includes the option “view pixel history.” Of course, other techniques may be used to access/initiate the pixel history.

Specifically, in the example of FIG. 1, the developer may access a pixel history system 132, which is configured to provide the developer with information about the pixel 130, and, more specifically, is configured to intercept the call(s) 104 and bundle the call data and associated asset data into an event 106, which, as described below, may be used to provide the developer with information about the primitives 110, depth 112, stencil values 114, and color 116 that were used by the calls 104 to invoke the graphics interface 108 and obtain the pixel 130 in the first place. The pixel history system 132 provides this information within a graphical user interface, shown as a pixel history window 142 in FIG. 1.

In operation, then, the developer may simply observe a visual representation on the display 124. When the developer observes a rendering error within the visual representation, e.g., within the frame 126, the developer may simply select the pixel 130 that includes the rendering error, e.g., by clicking on or otherwise designating the pixel 130. The developer is then provided with the pixel history window 142, which identifies the pixel 130 and provides the sequence or listing of events 106 (e.g., events 106a, 106b) that led to the rendering of the pixel 130 within the frame 126. In the pixel history window 142, the events 106a and 106b are browsable, so that, for example, the developer may scroll through the events 106a and 106b (and other events 106, not shown in FIG. 1), and then select one of these events 106, or information presented therewith, in order to determine whether and how the selected event contributed to the rendering error observed with respect to the pixel 130. In this way, the developer may quickly determine a source of a rendering error, and may thus correct the rendering error. Moreover, since the events 106a, 106b represent points in time at which associated calls occurred, the developer is provided with information about when an error occurred, which may be useful even when other sources of error are present. For example, an error in the graphics driver 118 may cause the rendering error in the pixel 130, and the event 106b may pinpoint when the rendering error occurred, so that the developer may consider an operation of the graphics driver 118 (or other hardware) at that point in time, to determine whether such operation contributed to the rendering error.

Rendering errors such as those just referenced may be very small or very large, in either spatial or temporal terms. For example, the rendering error may be limited to a single pixel, or may include a large object in the frame 126 (such as the building or car just mentioned). The rendering error may exist for several seconds, or may appear/disappear quite rapidly. Moreover, the rendering error may not appear exactly the same within different executions of the graphics application 102. For example, in a video game, a particular scene (and associated rendering error) may depend on an action of a player of the game. If the player takes a different action, the resulting scene may render slightly differently, or completely differently. In such cases, it may be difficult even to view the rendering error again, or to be certain that the rendering error occurred.

Accordingly, the pixel history system 132 is configured, in example implementations, to implement techniques for capturing, storing, and re-playing the calls 104 to the graphics interface 108. Specifically, for example, a capturing tool 134 may be used that is configured to intercept the calls 104 as they are made from the graphics application 102 to the graphics interface 108.

In example implementations, the capturing tool 134 generally operates to monitor calls 104 made by the graphics application 102 to the graphics interface 108, and to package the calls and associated asset data within an event 106 and put the event(s) 106 into a run file 136. More specifically, the capturing tool 134 captures calls 104 made in connection with the frame 126, along with a sequence of calls made in connection with previous frames that help define a state of the frame 126. The capture tool 134 may then store the call(s) within the event 106, and put event 106 into run file 136. Accordingly, the captured calls may be re-executed using executable 137 so as to re-render the frame 126.

Thus, the event 106 may serve as a data bundle for call 104 and asset data 109. The event 106 may, for example, include zero or more calls 104, with or without a particular type of associated asset data 109 for each call 104, and the pixel history system may generate more than one event 106. For example, the capturing tool 134 may capture a call 104 and associated asset data 109 and store them within the event 106.

In some example implementations, only those calls contributing to the frame 126 may be stored as event(s) 106, perhaps using a memory 135, within the run file 136. Also, since the calls 104 are captured at the level of standard calls made to the graphics interface 108, it should be understood that capturing and re-rendering may be performed in connection with any graphics application that uses the graphics interface 108, without necessarily needing to access source code of the graphics application(s), and without dependency on either the graphics driver 118, graphics hardware, or the computer 122. Furthermore, virtually any graphics application 102 and/or graphics interface 108 (or graphics application programming interface) may be compatible with the pixel history system, so long as there is a way, for examples to capture, modify, and replay the calls 104 to the graphics interface 108 from the graphics application 102.

In use, then, a developer may observe a rendering error during execution of the graphics application 102, and may then re-execute the graphics application 102, but with the pixel history system 132 inserted so as to capture the calls 104. In this way, the run file 136 may be captured that represents, in a minimal way, the rendered frame 126 in a manner that allows the developer to observe the rendering error in an easy, repeatable way.

Of course, the just-described operations and features of the pixel history system 132 of FIG. 1 are just examples, and other techniques may be used to provide the developer with the portion of the visual representation including the rendering error. For example, it is not necessary to perform such recapturing operations as just described. Rather, for example, the visual representation may simply be replayed so that the associated data (e.g., events) may be observed frame-by-frame as the visual representation replays. Additionally, or alternatively, a buffer may be embedded within the graphics application 102, which records a specified number of the most recent calls 104. Then, for example, when the user selects a pixel 130 to view the history of the pixel 130, the pixel history system 132 may use the buffer to determine/store the call(s) 104 relating to at least the frame portion 128 containing the pixel 130.

However the developer is provided with the frame 126 for selection of the pixel 130, the pixel history system 132 may receive the selection thereof using a pixel parser 138, which may extract all of the events 106 that are relevant to the selected pixel 130 (e.g., the events 106a, 106b), which may then be provided to the developer by display logic 140 in the form of the pixel history window 142. As shown, the pixel history window 142 may include a pixel identifier 143 that identifies the selected pixel 130 (e.g., by providing a row, column of the pixel 130 within the display 124, or by other suitable identification techniques).

Upon receiving the selection of the pixel 130, the pixel parser 138 may select only those events 106 relevant to the pixel 130 (e.g., used to render the pixel 130), along with the associated data or other information associated with each event (e.g., associated instances of the primitive 110, depth 112, stencil 114, and color 116). For example, in FIG. 1, the pixel history window 142 shows the event 106a as including a primitive 110a, while the event 110b includes the primitive 110b. Further in FIG. 1, the events 106a, 106b include pixel values 142a, 142b, respectively, where the term pixel values is used to refer generically to values for the type of information referenced above (e.g., depth 112, stencil 114, color 116), including other types of pixel information not necessarily described explicitly herein.

The provided events 106a, 106b also may include test results 146a, 146b, respectively. Such test results 146a, 146b refer generally to the fact that the graphics application 102 may specify that the pixel should only appear, or should only appear in a specified manner, if a certain precondition (i.e., test) is met. Various types of such pixel tests are known. For example, a depth test may specify that the pixel 130 should only be visible if its depth is less than that of another specified pixel, and should not otherwise be visible (i.e., should be “behind” the other specified pixel). Other known types of tests include, for example, the stencil test or the alpha test, which operate to keep or discard frame portions based on comparisons of stencil/alpha values to reference values. For example, as is known, the stencil test may help determine an area of an image, while the alpha test refers to a level of opaqueness of an image, e.g., ranging from completely clear to completely opaque. These tests may be interrelated, e.g., the stencil value 114 may be automatically increased or decreased, depending on whether the pixel 130 passes or fails an associated depth test.

Thus, for example, the call 106 may attempt to render the pixel 130; however, if the pixel 130 fails an associated depth test that the developer intended the pixel 130 to pass (or passes a depth test it was supposed to fail), then the pixel 130 may not appear (or may appear), thus resulting in a visible rendering error. In other words, for example, it may occur that the call 106 attempts to affect the pixel 130 and fails to do so. In this case, the pixel history window 142 may provide the results of the (failed) test, so that the developer may judge whether the test was the source of the perceived error. Specifically, in the example of FIG. 1, the event 106b is illustrated as being associated with a failed depth test, and details associated with this failed depth test may be provided within the test results 146b.

The display logic 140 may be configured to interact with the run file 136 (and/or memory 135), the executable 137, and the pixel parser 138, to provide the pixel history window 142 and/or other associated information. For example, the display logic 140 may use the executable to re-render the frame 126, frame portion 128, and/or the pixel 130 itself. The pixel history window 142 may appear on the same display 124 as the rendered frame 126, or may appear on a different display. There may be numerous configurations on how to display the information; for example, all of the information may be displayed in a pop-up window. From the information displayed in the pixel history window 142, the developer or other user may then determine a source of a rendering error associated with the pixel 130, such as, for example, why a depicted building that included the pixel 130 was white when it was intended to be blue.

It should be understood that, in the example of the blue building that renders white, or in other rendering errors, there may be multiple sources of the rendering error. For example, there may be an error with the call 104, and/or with the primitive 110. Further, there may be an error with the graphics driver 118 implementing the graphics interface 108, or there may be an error in the graphics hardware 120. The pixel history system 132, by providing the pixel history window 142, may thus assist the developer in determining one or more sources of the observed rendering error.

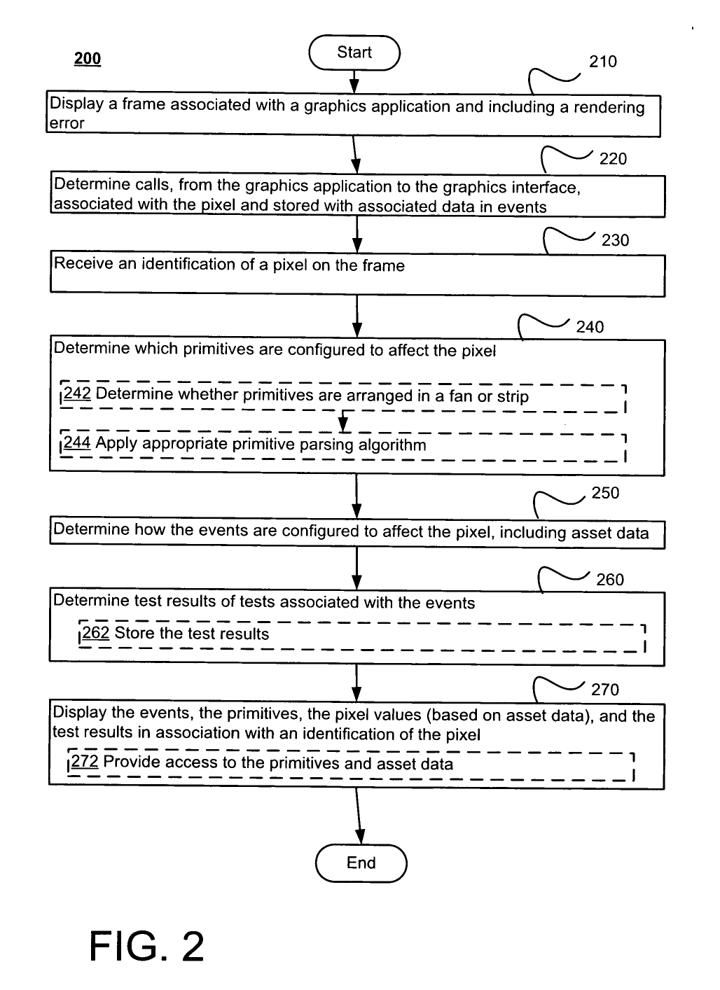

FIG. 2 is a flow chart illustrating example operations of the system of FIG. 1. In the example of FIG. 2, a frame is displayed in association with a graphics application (210), the frame including a rendering error. For example, as referenced above, a developer may view a visual representation, such as a computer game, and the visual representation may include the frame 126 in which the developer observes a rendering error, such as an incorrect color or depth. The developer may then re-render the frame 126, and may use the capturing tool 134 to capture the frame 126, or, more specifically, may capture the frame portion 128, by capturing calls 104 generated by the graphics application 102 when provided to the graphics interface 108. The capturing tool 134 may store the captured calls in events 106 and place the events within the run file 136, and may re-render the frame 126 when directed by the developer, using the executable 137. As described above, the events may also store asset data associated with the calls. As should be apparent, the events may be for a single frame (e.g., frame 100 or other designated frame), or may be for a number of frames (e.g., from a load screen to a user exit). As described, the capturing tool 134 may capture all calls 104 to the graphics interface 108 (e.g., that are associated with the frame 126 or frame portion 128), as well as all data associated with the calls 104.

Calls associated with the pixel (e.g., that “touch” the pixel), from the graphics application to the graphics interface, may then be determined. The calls may be stored in one or more events with associated data (220). For example, the capturing tool 134 may capture the calls 104 and store the calls in the events 106. The pixel parser 138 may then, for example, extract the events that are associated with the pixel 130.

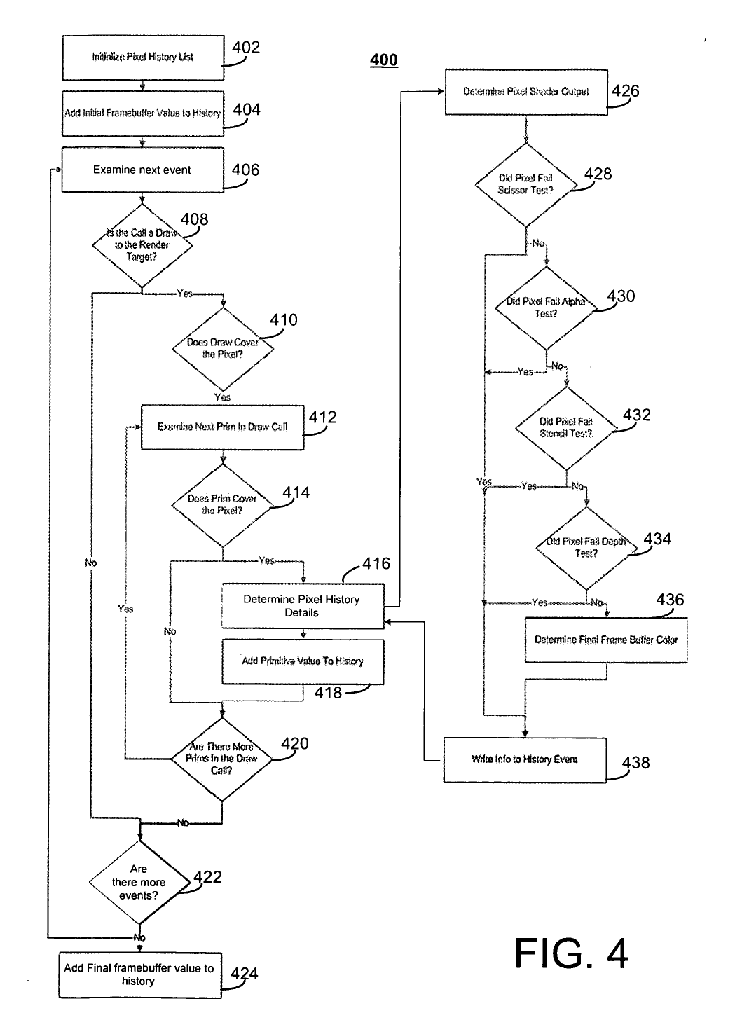

An identification of a pixel within the frame may then be received (230). For example, the pixel history system 132, e.g., the pixel parser 138, may receive a selection of the pixel 130 from within the frame 126. For example, the developer who requested the re-rendering of the frame 126 may “click on” the pixel 130 as the pixel 130 displays the rendering error. The pixel parser 138 may then determine which pixel has been selected (e.g., the pixel 130 may be designated as pixel (500, 240)). In some implementations, as described in more detail below with respect to FIG. 4, the pixel parser 138 may first select or designate the frame portion 128, so as to restrict an amount of data to analyze, based on which pixel is selected.

Each call may include multiple primitives; those primitives that are configured to affect the pixel may be determined (240). For example, the pixel parser 138 may parse each of the events 104 to determine the primitive(s) 110. Since, as referenced, there may be thousands of primitives within even a single event 106, it may be difficult to parse and extract each primitive. Consequently, different techniques may be used, depending on a given situation/circumstance.

For example, it may be determined whether the primitives are arranged in a particular format, such as one of several known techniques for arranging/combining primitives. For example, it may be determined whether the primitives are arranged in a fan or a strip (242), and, consequently, it may be determined which primitive parsing algorithm should be used (244). Further discussion of how the primitives 110 are obtained is provided in more detail below with respect to FIG. 4.

Then, it may be determined how the events associated with the pixel 130 are configured to affect the pixel 130, including asset data (250). Various examples are provided above with regard to FIG. 1 of how the events 106 may affect the pixel 130, e.g., by setting a color or depth of the pixel 130. As also described, the events 106 may be configured to affect the pixel 130, but may not actually do so, e.g., due to an erroneous test that caused the event not to operate in a desired manner. As should be understood from the above, even if the call 104 is correct, the associated primitive or asset data may be causing the rendering error, inasmuch as the asset data is used by the graphics interface 108 to complete the function(s) of the graphics interface 108. Asset data determined at this stage may include, for example, a texture, shading, color, or mesh data (e.g., used to mesh primitives (e.g., triangles) into a desired form).

Test results of tests associated with one or more of the events may be determined (260) and stored (262). For example, the pixel parser 138 may determine that a given event was associated with a depth test, such that, for example, the pixel 130 was supposed to become visible as being in front of some other rendered object. The test results, e.g., the test results 146b of the event 106b of FIG. 1, may indicate whether the pixel passed this depth test, so that a pass/fail of the depth test may provide the developer with information as to a possible source of error associated with the rendering of the pixel 130.

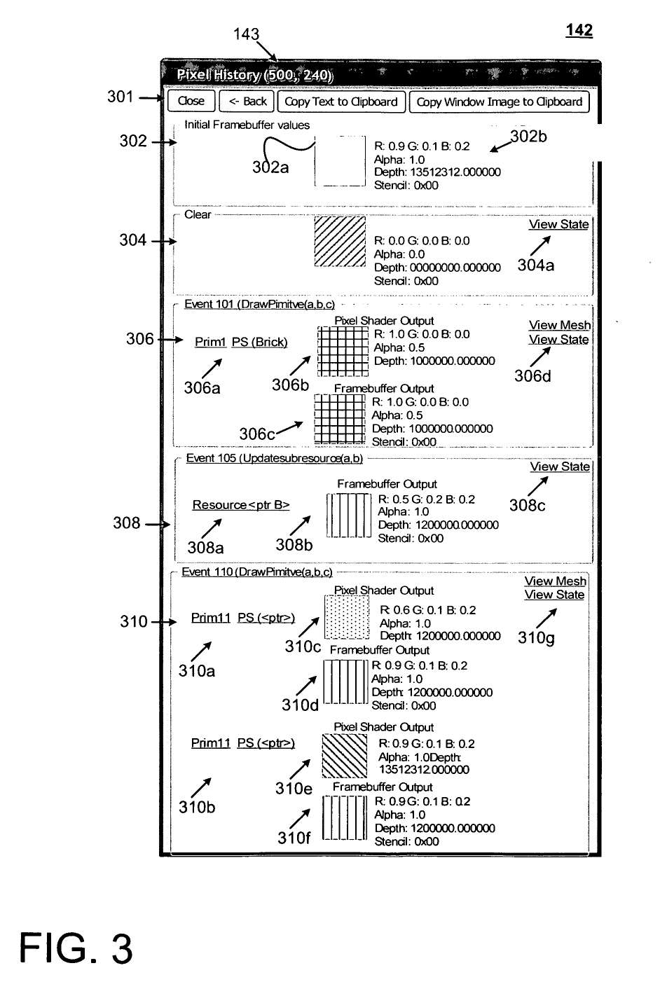

The events, primitives, pixel values/asset data, and test results may then be displayed in association with an identification of the pixel (270). For example, as discussed above and as illustrated in more detail with respect to FIG. 3, the display logic 140 may provide the pixel history window 142, in which the temporal sequence of the events (e.g., events 106a, 106b) that affect (or were supposed to have affected) the pixel 130 are displayed. As shown in FIG. 1, the events 106a, 106b may include, respectively, the associated primitives 110a, 110b, pixel values 142a, 142b, and test results 146a, 146b. The pixel history window 142 also provides the pixel identifier 143. In an alternative embodiment calls may be displayed with the events, primitives, pixel values/asset data, and test results in association with the identification of the pixel.

By providing the pixel history window 142, the pixel history system 132 may, for example, provide the developer with direct and straight-forward access to the primitives and asset data used within each event (272). For example, the primitives 110a, 110b may provide a link that the developer may select/click in order to learn more information about the selected primitive. Similarly, the pixel values 142a, 142b may provide information about a color of the pixel 130 after the associated event 106a, 106b, and the developer may, for example, compare this information to an associated alpha value (i.e., degree of opaqueness) to determine why the pixel 130 was not rendered in a desired manner.

FIG. 3 is an example embodiment of the pixel history window 142 provided by the system 100 of FIG. 1. As may be appreciated from the above description, the pixel history window 142 may be provided to a developer in response to a selection by the developer of the pixel 130 from within the frame 126. The pixel history window 142 includes the pixel identifier 143, as well as buttons 301 that allow the developer to perform some useful, associated functions, such as, for example, closing the pixel history window 142, going back (or forward) to a previous (or next) pixel history window, or copying text and/or images to the clipboard, e.g., for use in a related program (e.g., emailing the contents of the pixel history window 142 to another developer).

The pixel history window 142 also includes a first event 302 that represents a value of the pixel 130 at an end of a previous frame. The event 302 includes a color swatch 302a that illustrates a color value associated with the event 302 for easy visualization. Pixel values 302b may specify, for example and as shown, float representations of the color values, as well as alpha, depth, and stencil values.

The event 304 represents a clear event, which sets values for the above-referenced pixel values at “0.” The event 304 also includes a link 304a that provides the developer with state information about a state of associated hardware (e.g., the graphics driver 118, graphics hardware 120, or the computer 122) at a point in time associated with the event 302. For example, the state information may be rendered in a separate window.

The event 306 identifies a first event (i.e., event 101) associated with rendering the pixel 130. In this example, the event 306 is associated with drawing a primitive, so that link(s) 306a provide the developer with direct access to the specified primitive. Consequently, for example, the developer may view characteristics of the identified primitive, in order to ensure that the characteristics match the desired characteristics. The event 306 also includes, similarly to the clear event 304, pixel values, such as a pixel shader output 306b and a framebuffer output 306c, along with associated color, alpha, depth, and/or stencil values at that point in time. Also in the event 306, links 306d provide the developer with access to hardware state information (as just referenced) and access to mesh values associated with a meshing of the identified primitive(s) into a desired, higher-level object.

The event 308 is associated with an event (i.e., the event 105) commanding the graphics interface 108 to update a resource. As before, the event 308 may include pixel values of an associated framebuffer output 308b, as well as a link 308c to state information.

Finally in FIG. 3, an event 310 (e.g., the event 110, as shown) illustrates an example in which multiple primitives of the event 310 are included, so that the primitives 310a and 310b may be broken out separately, as shown. Generally speaking, primitive information may include, for example, a primitive type (e.g., triangle, line, point, triangle list, or line list). In this case, associated pixel shader output 310c and framebuffer output 310d may be provided for the primitive 310a, while associated pixel shader output 310e and framebuffer output 310f may be provided for the primitive 310b. Finally in the event 310, links 310g may again be provided, so that, for example, the developer may view the mesh values for the mesh combination of the primitives 310a, 310b.

FIG. 4 is a flow chart 400 illustrating example operations used by the system of FIG. 1 to implement the pixel history window of FIG. 3. In the example of FIG. 4, a pixel history list is initialized (402). Then an initial framebuffer value may be added to the pixel history (404). For example, in event 302 of FIG. 3, the color, the alpha, depth, and stencil values 302b of a selected pixel may be determined.

An event may next be examined (406). For example, in event 306 the DrawPrimitive(a,b,c) call of the event (i.e., event 101) may be examined. It may then be determined, for the event, whether the call is a draw to the render target (408). The render target, for example, may be the frame including an erroneously rendered pixel as selected by the graphics developer, as described above, or may be a frame for which the developer wishes to understand or optimize related calls (events). If the call is not a draw to the render target, then the next event (if any) may be examined (422).

If, however, the call is a draw call to the render target, it may be determined whether the draw call covers the pixel (410). In this context, an example for determining whether the draw call covers the pixel is provided below in Code Section 1, which is intended to conceptually/generically represent code or pseudo-code that may be used:

Code Section 1

```
DrawIntersectsPixel (Call c)
{
  set pixel of rt [render target] at point p to white
  disable alpha, depth, stencil tests
  set blend state to always blend to black
  execute call c
  if pixel of rt at point p is black
  {
    returns true
  }
  else
  {
    returns false
  }
}
```

If the draw call covers the pixel (i.e. Code Section 1 returns true) then it may be determined whether a primitive of the draw call covers the pixel (414). In this context, an example for determining the first primitive that covers the pixel is provided below in Code Section 2, which is intended to conceptually/generically represent code or pseudo-code that may be used:

Code Section 2

```
  FindFirstAffectedprim( Call c, Int minPrim, Int maxPrim, out Int
affectedPrim )
  {
    while( minPrim < maxPrim )
    {
      Int testMaxPrim = ( minPrim + maxPrim + 1 ) / 2
        // The “+ 1” is so we round up
      set pixel of rt at point p to white
      set blend state to always blend to black
      MakeModifiedDrawCall( c, minPrim, testMaxPrim )
      if( pixel of rt at point p is black )
      {
      // It turned black...there is at least one affecting
    prim in the range
      if( minPrim == testMaxPrim − 1 )
      {
        // We only rendered one prim, so minPrim is the
      one
        affectedPrim = minPrim
        return true;
      }
      else
      {
        // We tested too many prims...need to back up
        maxPrim = testMaxPrim
      }
    }
      else
      {
        // Didn't hit a black pixel yet...no affecting
prims in range...move forward
        minPrim = testMaxPrim
      }
    }
    return false
  }
```

After finding a primitive that covers the pixel, the history details for the pixel may be determined (416). Details of example operations for determining the pixel history details are provided below (426-438).

After the history details for the primitive are determined as described above, the primitive value may be added to the history (418). Then if there are more primitives in the draw call, the next primitive may be examined (420), using the techniques just described. Once there are no more primitives in the draw call and no more events to examine, the final framebuffer value may be added to the history (424).

In determining the history details (416), first the pixel shader output may be determined (426). For example, the values associated with item 310c of event 310 may be determined. Then the pixel may be tested to determine whether it fails any one of several tests, including for example a scissor test, an alpha test, a stencil test, and a depth test. Alternative embodiments may include a subset and/or different tests and/or different sequences of tests other than those specified in this example.

For example, first it may be determined whether the pixel fails the scissor test (428). The scissor test may include a test used to determine whether to discard pixels contained in triangle portions falling outside a field of view of a scene (e.g., by testing whether pixels are within a “scissor rectangle”). If the pixel does not fail the scissor test, then it may be determined whether the pixel fails the alpha test (430). The alpha test may include a test used to determine whether to discard a triangle portion (e.g., pixels of the triangle portion) by comparing an alpha value (i.e., transparency value) of the triangle potion with a reference value. Then, if the pixel does not fail the alpha test, the pixel may be tested to determine whether it fails the stencil test (432). The stencil test may be a test used to determine whether to discard triangle portions based on a comparison between the portion(s) and a reference stencil value. If the pixel does not fail the stencil test, finally the pixel may be tested to determine whether it fails the depth test (434). The depth test may be a test used to determine whether the pixel, as affected by the primitive, will be visible, or whether the pixel as affected by the primitive may be behind (i.e., have a greater depth than) an overlapping primitive.

If the pixel fails any of the above mentioned tests, then this information may be written to the event history (438) and no further test may be performed on the pixel. In alternative embodiments however, a minimum set of tests may be specified to be performed on the pixel regardless of outcome.

If however the pixel passes all of the above mentioned tests, then final frame buffer color may be determined (436). For example, the color values associated with item 310d of event 310 may be determined. Then the color value and the test information may be written to the event history for this primitive (438).

Using the above information and techniques, the developer may determine why a particular pixel was rejected during the visual representation (e.g., frame 126). For example, in some cases, a target pixel may simply be checked without needing to render, such as when the target pixel fails the scissor test. In other cases/tests, a corresponding device state may be set, so that the render target (pixel) may be cleared and the primitive may be rendered. Then, a value of the render target may be checked, so that, with enough tests, a reason why the pixel was rejected may be determined.

Based on the above, a developer or other user may determine a history of a pixel in a visual representation. Accordingly, the developer or other user may be assisted, for example, in debugging associated graphics code, optimizing the graphics code, and/or understanding an operation of the graphics code. Thus, a resulting graphics program (e.g., a game or simulation) may be improved, and a productivity and skill of a developer may also be improved

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
receiving a selection of a pixel rendered on a display by a graphics application making a plurality of calls to a graphics application interface;
determining at least one event, the at least one event including at least one call of the plurality of calls that is associated with the rendering of the pixel on the display; and
providing the at least one event in association with an identification of the pixel.

2. The method of claim 1 wherein receiving a selection of a pixel rendered on a display by a graphics application making a plurality of calls to a graphics application interface comprises:
capturing a subset of the plurality of calls related to the pixel, including the at least one call;
storing the subset of the plurality of calls in a run file;
executing the run file to display a visual representation based on the subset of the plurality of calls; and
receiving the selection of the pixel in response to the display of the pixel within the visual representation.

3. The method of claim 1 wherein receiving a selection of a pixel rendered on a display by a graphics application making a plurality of calls to a graphics application interface comprises:
displaying at least a portion of a frame comprising the pixel on the display; and
receiving the selection of the pixel in response to the displaying of the at least the portion of the frame.

4. The method of claim 1 wherein determining at least one event, the at least one event including at least one call of the plurality of calls that is associated with the rendering of the pixel on the display, comprises:
receiving a run file comprising the at least one event; and
determining the at least one event including the at least one call of the plurality of calls that is associated with the rendering of the pixel on the display, using the run file.

5. The method of claim 1 wherein determining at least one event, the at least one event including at least one call of the plurality of calls that is associated with the rendering of the pixel on the display comprises:
determining the event associated with the pixel as affecting the rendering of the pixel.

6. The method of claim 1 wherein determining at least one event, the at least one event including at least one call of the plurality of calls that is associated with the rendering of the pixel on the display comprises:
determining the event associated with the pixel as being configured to affect the rendering of the pixel; and
determining that the event failed to affect the rendering of the pixel.

7. The method of claim 1 wherein determining at least one event, the at least one event including at least one call of the plurality of calls that is associated with the rendering of the pixel on the display comprises:
determining asset data used by the corresponding call in the rendering of the pixel.

8. The method of claim 1 wherein determining at least one event, the at least one event including at least one call of the plurality of calls that is associated with the rendering of the pixel on the display comprises:
determining at least one primitive associated with the corresponding call in the rendering of the pixel.

9. The method of claim 1 wherein providing the at least one event in association with an identification of the pixel comprises:
displaying the identification of the pixel in association with the at least one event, the at least one event including a sequential order of events associated with the rendering of the pixel.

10. The method of claim 1 wherein providing the at least one event in association with an identification of the pixel comprises:
displaying at least one pixel value of the pixel in association each event within a sequential order of events.

11. The method of claim 1 wherein providing the at least one event in association with an identification of the pixel comprises:
displaying a primitive associated with the at least one call of the plurality of calls of each event within a sequential order of events, wherein the primitive is associated with the rendering of the pixel on the display.

12. The method of claim 1 wherein providing the at least one event in association with an identification of the pixel comprises:
displaying the identification of the pixel in association with the at least one event, the at least one event including a sequential order of events associated with the rendering of the pixel; and
providing access to asset data associated with the least one event.

13. The method of claim 1 wherein providing the at least one event in association with an identification of the pixel comprises:
providing a browsable pixel history window in which the at least one event is provided in the context of a temporal sequence of events associated with the pixel, wherein the at least one event provides a link to additional information regarding the at least one event.

14. A system comprising:
a computing device; and
instructions that when executed on the computing device cause the computing device to:
determine at least a portion of a frame associated with an identified pixel;
capture a series of events associated with the portion of the frame, wherein each event comprises one or more calls from a graphics application to a graphics application interface;
determine a set of pixel values associated with each event of the series of events; and
provide at least a portion of the set of pixel values in association with each event of the series of events associated with the identified pixel.

15. The system of claim 14 wherein the instructions cause the computing device to:
display the frame, wherein the frame includes the identified pixel;
receive a selection of the identified pixel; and
determine the at least a portion of the frame including the identified pixel.

16. The system of claim 14 wherein the instructions cause the computing device to:
replay the captured series of events;
determine an effect of each of the one or more calls of each event on the identified pixel; and
capture the set of pixel values based on the effect.

17. The system of claim 14 wherein the instructions cause the computing device to:
determine an event of the set of events associated with the identified pixel, wherein the event is configured to affect a rendering of the identified pixel;
determine that the event fails to affect the rendering of the identified pixel;
determine a result of the event failing a test associated with the rendering of the pixel; and
provide the event in association with the identified pixel and the result.

18. A computer readable medium having stored thereon computer-readable instructions implementing a method in combination with an application running on a computing device and rendering a visual representation to a display of the computing device, the application rendering the visual representation as a series of visual frames according to a plurality of calls from a graphics application to an application programming interface, wherein at least one frame of the series of visual frames contains a pixel, the method comprising:
receiving an identification of the pixel;
determining at least one call of the plurality of calls associated with the rendering of the at least one frame of the series of visual frames, wherein the at least one call is associated with a primitive and asset data associated with the rendering of the pixel; and
providing the at least one call within a pixel history window on the display.

19. The method of claim 18 wherein receiving an identification of the pixel comprises:
determining a selection of the pixel by a user during the rendering of the visual representation; and
providing an option to the user for viewing a history of the pixel.

20. The method of claim 18 wherein providing the at least one call within a pixel history window on the display comprises:
displaying an event including the at least one call in association with a set of pixel values associated with the pixel and the event; and
providing the primitive and asset data in association with the event.
